(19) United States
(12) Patent Application Publication
(10) Pub. No.: US 2014/0333889 A1
(43) Pub. Date: Nov. 13, 2014

(54) EYEGLASSES STRUCTURE

(71) Applicant: TSAIR YUARN INDUSTRIAL CO., LTD., Tainan City (TW)

(72) Inventor: PAUL HUANG, TAINAN CITY (TW)

(73) Assignee: TSAIR YUARN INDUSTRIAL CO., LTD., Tainan City (TW)

(21) Appl. No.: 13/891,355

(22) Filed: May 10, 2013

(51) Int. Cl. G02C 1/06

(52) U.S. Cl. CPC G02C 1/06
USPC 351/140

(57) ABSTRACT

An eyeglasses is provided, in which two location holes are respectively provided symmetrically to the center of the frame thereof, and a pivot connecting slot is provided at the middle portion of the frame. Location through-holes corresponding to the location holes of the frame are provided respectively on lenses. A fastening member has a pivot connecting portion provided at the bottom end which corresponds to the pivot connecting slot and is fitted therein, and two location pins used to fit with the location holes of the frame and the location through-holes of the lenses. Without the use of any tool, the lenses can be located in place and combined firmly with the frame without coming off. Therefore, the assembly of lenses and the frame can be easily and quickly conducted so as to increase practical value in its overall implementation.

### BACKGROUND OF THE INVENTION

1. Field of the Invention

The present invention relates to an eyeglasses structure, more particularly to a novel eyeglasses structure in which the lenses can be located in place and combined firmly with the frame without coming off, without the use of any tool, hence the assembly of lenses and the frame can be easily and quickly conducted so as to increase practical value in its overall implementation.

2. Brief Description of Prior Arts

Generally, eyeglasses according to its intended use can be divided into myopia lenses for nearsighted eyes, presbyopia lenses for presbyopia, sunglasses for sun shading, and goggle for eyes protection in working. Each type of the above eyeglasses has lenses mounted within a frame and temples pivotally located at both sides of the frame as its basic structure, whatever the application type would be. Configuring like this, eyeglasses can be ready for wearing by users.

For common eyeglasses, the combination of its frame and lenses are substantially conducted as below. Two lens mounting apertures are provided on the frame of eyeglasses for lens mounting. The outer side of each mounting aperture has a threading end with tap hole for fixing by a screw. After the lenses are processed to match with the lens mounting apertures, the lenses are inserted into the mounting apertures and screws are threaded at the threading ends for fixing, so that the lenses can be held firmly within the lens mounting apertures without falling off. In this way, the eyeglasses are accomplished and ready for wearing by users.

The above eyeglasses can achieve expected effect of allowing the lenses to be held in the frame, however, as screws have to be used for fixing the lenses in positions when the lenses are to be mounted into the lens mounting apertures of the frame without falling off, not only much labor time has to be consumed for threading operation but also a corresponding screwdriver is needed for threading the screws. If a corresponding screwdriver is unavailable on hand, the threading operation cannot be conducted and hence assembly and disassembly operation cannot be performed. Thus, there are still rooms for improvement on its overall structure.

In view of the above disadvantages, the inventor of the present invention hereby proposes an eyeglasses structure according to the research and improvement conducted on the conventional product and based on his abundant experiences in both R&D and manufacturing of associated industries, so as to achieve the purpose of better implementation value.

### SUMMARY OF THE INVENTION

The main object of this invention is to provide an eyeglasses structure, in which the lenses can be located in place and combined firmly with the frame without coming off, without the use of any tool, and hence the assembly of lenses and the frame can be easily and quickly conducted so as to increase practical value in its overall implementation.

The above object and effect can be achieved by the following specific technical means.

The eyeglasses structure of the present invention comprises a frame, two lenses and a fastening member.

The frame has two location holes respectively provided symmetrically at the middle portion thereof, and a pivot connecting slot is provided at the center thereof.

The lenses have location through-holes corresponding respectively to the location holes of the frame provided thereon.

The fastening member has a pivot connecting portion provided at the bottom end which corresponds to the pivot connecting slot and is fitted therein, and two location pins used to fit with the location holes of the frame and the location through-holes of the lenses.

According to a preferred embodiment of the present invention, the frame has a snap-fit recess formed on the central upper edge and above a place corresponding to the pivot connecting slot, while a snap-fit hook, corresponding to the snap-fit recess of the frame, is provided on the upper end of the fastening member.

According to a preferred embodiment of the present invention, the frame has two lens mounting portions respectively provided at two sides thereof, and the lenses are respectively located and mounted on the lens mounting portions.

According to a preferred embodiment of the present invention, the lens is a single-piece lens.

### BRIEF DESCRIPTION OF ACCOMPANYING DRAWINGS

The present invention will be better understood by the detailed description of a preferred embodiment with reference to the accompanied drawings, in which:

FIG. 1 is a perspective exploded schematic exploded view of the present invention.

FIG. 2 is a schematic sectional side view showing the assembly process of the present invention.

FIG. 3 is a schematic sectional view showing the assembly structure (I) of the present invention.

FIG. 4 is a schematic sectional view showing the assembly structure (II) of the present invention.

FIG. 5 is a schematic sectional top view showing the assembly structure of the present invention.

FIG. 6 is a schematic rear view showing the assembly structure of the present invention.

FIG. 7 is a schematic sectional bottom view showing the assembly of another embodiment of the present invention.

### DETAILED DESCRIPTION OF PREFERRED EMBODIMENTS

The technical contents, objects and effect of the present invention will become more apparent by the detailed description in conjunction with the accompanied drawings.

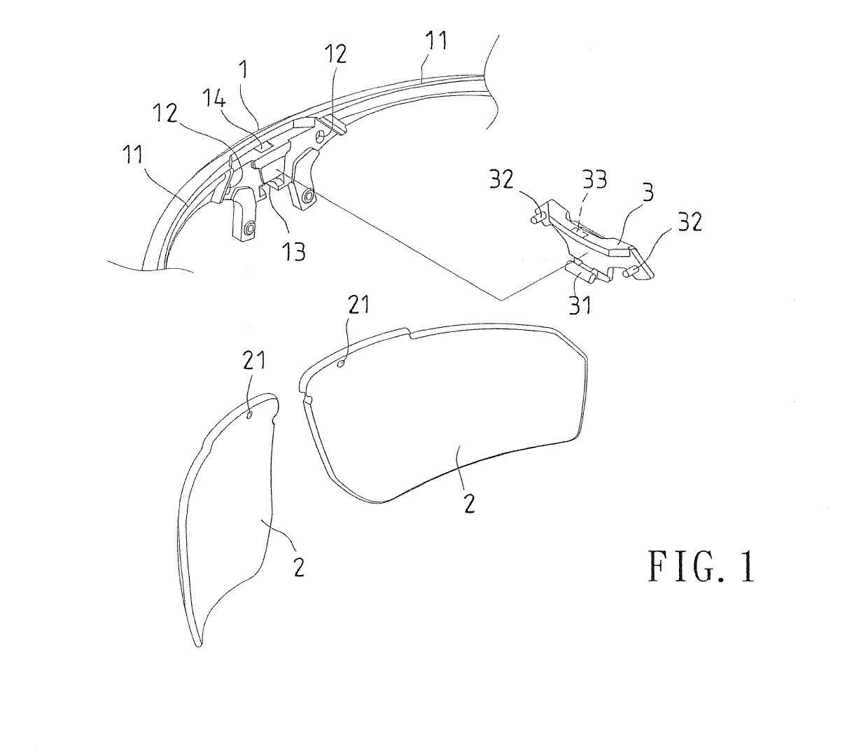

FIG. 1 is a perspective exploded schematic exploded view of the present invention. As shown in the figure, the present invention mainly comprises a frame (1), two lenses (2), and a fastening member (3).

The frame (1) has two lens mounting portions (11) respectively provided at two sides thereof, and two location holes (12) respectively provided symmetrically at the inner sides of the middle portion thereof. A pivot connecting slot (13) is provided at the center position of the frame (1), and a snap-fit recess (14) is provided on the central upper edge above the pivot connecting slot (13).

The lenses (2) are respectively located and mounted on the two lens mounting portions (11) of the frame (1), and the lenses (2) have location through-holes (21), corresponding respectively to the location holes (12) of the frame (1), provided thereon.

The fastening member (3) has a pivot connecting portion (31) provided at the bottom end which corresponds to the pivot connecting slot (13) and is fitted therein, and two location pins (32) used to fit with the location holes (12) of the frame (1) and the location through-holes (21) of the lenses (2). Moreover, a snap-fit hook (33) corresponding to the snap-fit recess (14) of the frame (1) is provided on the upper end of the fastening member (3).

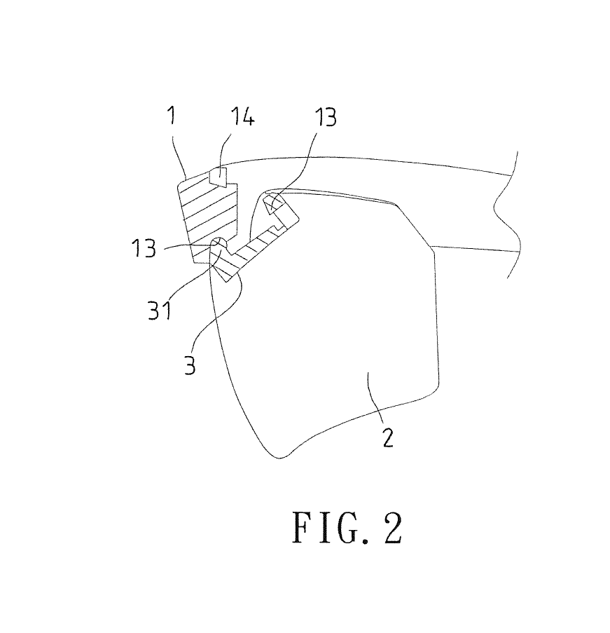

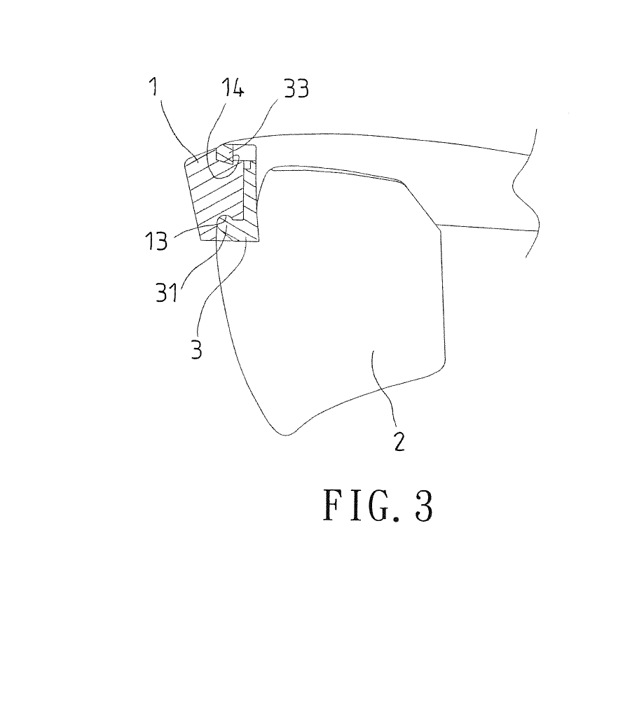

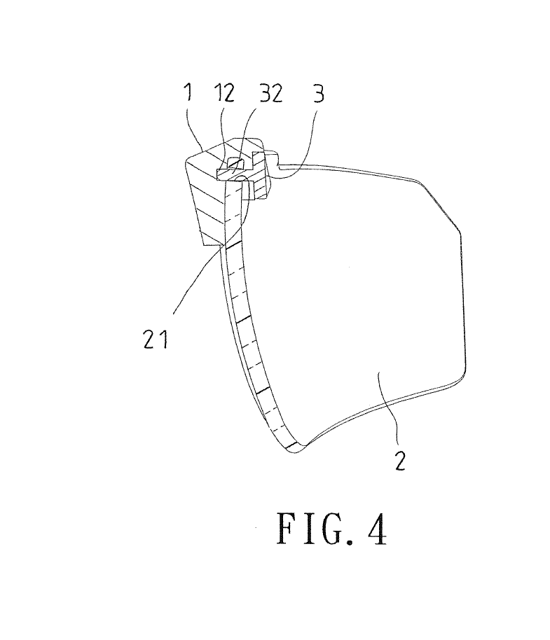

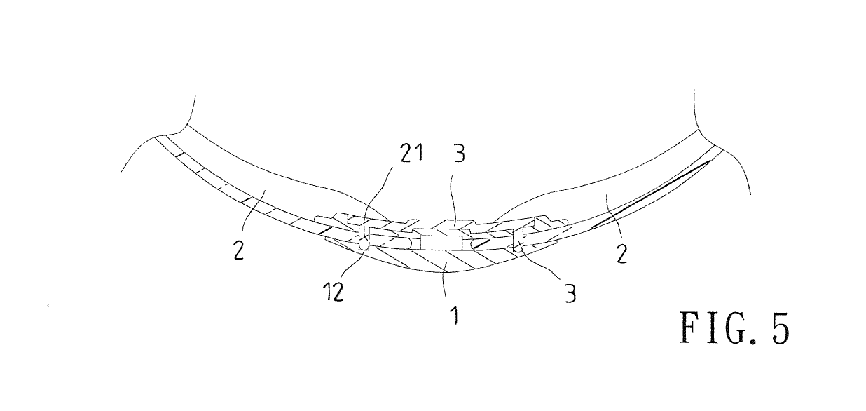

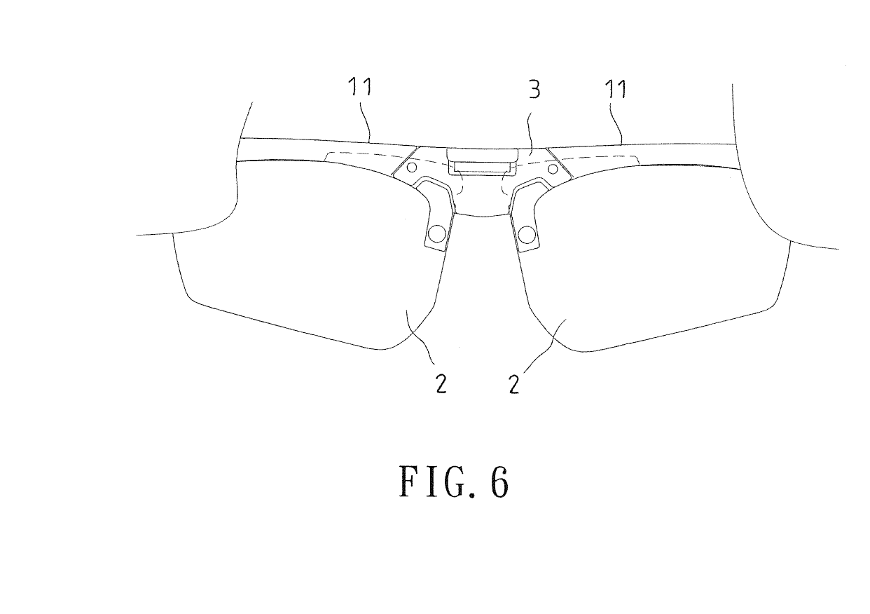

FIG. 2 is a schematic sectional side view showing the assembly process of the present invention. FIG. 3 and FIG. 4 are schematic sectional views respectively showing the assembly structure (I) and the assembly structure (II) of the present invention. In the assembling process as shown in these figures, firstly the lenses (2) are abutted against and located on the lens mounting portions (11) of the frame (1), and the location through-holes (21) are aligned with the location holes (12) of the frame (1). Next, the snap-fit hook (33) of the fastening member (3) is pushed upward with the pivot connecting portion (31) fitting in the pivot connecting slot (13) of the frame (1) as the center, as shown in FIG. 2, until the snap-fit hook (33) is locked in the snap-fit recess (14) of the frame (1), as shown in FIG. 3. At this moment, the location pins (32) penetrate through the location through-holes (21) of the lenses (2) and the location holes (12) of the frame (1), as shown in FIG. 4, so that the lenses (2) are firmly located and clamped between the frame (1) and the fastening member (3) without coming off, as shown in FIGS. 5 and 6.

When the lenses (2) are to be exchanged, the snap-fit hook (33) of the fastening member (3) is turned backward so as to release the locking between the snap-fit hook (33) of the fastening member (3) and the snap-fit recess (14) of the frame (1), simultaneously to retract the location pins (32) of the fastening member (3) from the location through-holes (21) of the lenses (2) and the location holes (12) of the frame (1). Then, the exchange of the lenses (2) can be conducted without assistance of any tool.

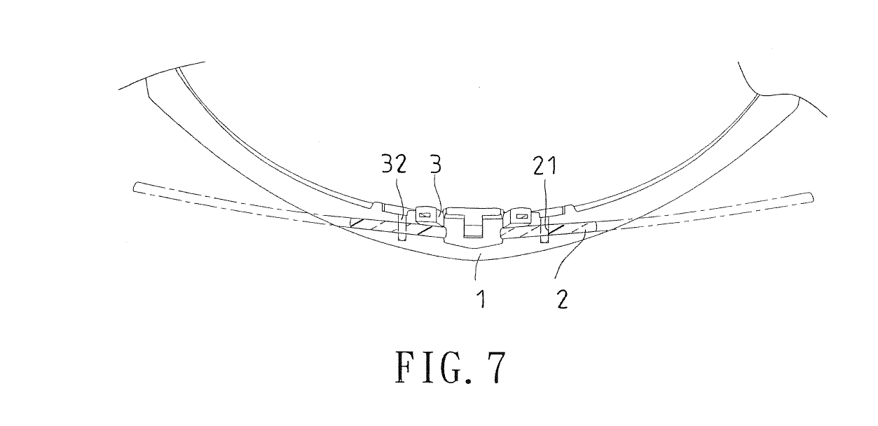

The lenses (2) of the present invention can be a design of two pieces respectively corresponding to the lens mounting portions (11) at two sides of the frame (1). On the other hand, as shown in FIG. 7, the lenses (2) of the present invention can be a single-piece design. In this case, the single-piece lens (2) is clamped between the frame (1) and the fastening member (3), and similarly the location pins (32) of the fastening member (3) are penetrated through the location through-holes (21) of the lenses (2) and the location holes (12) of the frame (1) so as to locate and clamp the lenses (2) between the frame (1) and the fastening member (3) without coming off.

Based on foregoing description of constitution and implementation of the present invention, the lenses can be located in place and combined firmly with the frame without coming off, without the use of any tool. Therefore, the assembly of lenses and the frame can be easily and quickly conducted so as to increase practical value in its overall implementation.

What is claimed is:

1. An eyeglasses structure, comprising a frame, two lenses and a fastening member, wherein:
said frame has two location holes respectively provided symmetrically at the middle portion thereof, and a pivot connecting slot is provided at the center position thereof;
said lenses has location through-holes, corresponding respectively to said location holes of said frame, provided thereon;
said fastening member has a pivot connecting portion provided at the bottom end which corresponds to said pivot connecting slot and is fitted therein, and two location pins used to fit with said location holes of said frame and said location through-holes of said lenses.

2. The eyeglasses structure as claimed in claim 1, wherein a snap-fit recess is provided on the central upper edge of said frame and above said pivot connecting slot, and a snap-fit hook corresponding to said snap-fit recess is provided on the upper end of said fastening member.

3. The eyeglasses structure as claimed in claim 1, wherein said frame has two lens mounting portions formed at both sides thereof, and said lenses are abutted against and located on said lens mounting portions of said frame.

4. The eyeglasses structure as claimed in claim 1, wherein said lenses is a single-piece design.
